(19) United States
(12) Patent Application Publication
(10) Pub. No.: US 2012/0061923 A1
(43) Pub. Date: Mar. 15, 2012

(54) BREATHABLE GASKET

(75) Inventor: Nusrat Farzana, Lee's Summit, MO (US)

(73) Assignee: BHA Group, Inc., Kansas City, MO (US)

(21) Appl. No.: 12/879,304

(22) Filed: Sep. 10, 2010

(51) Int. Cl. F16J 15/10

(52) U.S. Cl. 277/654

(57) ABSTRACT

An article, specifically a sealing gasket, includes at least one layer of microporous expanded polytetrafluoroethylene (ePTFE) and at least one air permeable layer. The sealing gasket simultaneously provides for the passage of air through the gasket while limiting the passage of liquid through the gasket. The sealing gasket may be used between two components that require air flow between the components while limiting the passage of liquid between the components. In one aspect, the air permeability is at least 0.01 cubic feet per minute (CFM) per square foot as determined by ASTM D 737 testing.

### BACKGROUND OF THE INVENTION

1. Field of the Invention

The invention relates to a sealing article, and more particularly, to an air permeable sealing gasket that limits the passage of liquid through the gasket.

2. Discussion of Prior Art

Gaskets may be used to provide a seal between two components that need to be joined together. Gaskets may further be used to provide a seal that limits or prevents the passage of liquid between the two components. However, some technologies require air flow between the components to solve pressure build up problems while simultaneously limiting the passage of liquid. Therefore, it would be useful to have a gasket that can be used in a variety of environments that allows for the passage of air through the gasket while simultaneously preventing the passage of liquid through the gasket.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect the present invention provides a gasket for providing a seal, comprising at least one layer of microporous expanded polytetrafluoroethylene (ePTFE), and at least one air permeable layer laminated to the at least one layer of microporous ePTFE, wherein the at least one layer of microporous ePTFE and the at least one air permeable layer are adapted to substantially limit the passage of liquid while allowing for the passage of air through the at least one layer of microporous ePTFE and the at least one air permeable layer.

In accordance with another aspect the present invention provides a gasket for providing a seal, comprising at least one microporous layer, at least one air permeable layer laminated to the at least one microporous layer, wherein the air permeability through the at least one air permeable layer laminated to the at least one microporous layer is at least 0.01 cubic feet per minute (CFM) per square foot at 0.5″ water column pressure drop as determined by ASTM D 737 testing.

In accordance with another aspect the present invention provides an article comprising at least one layer of microporous expanded polytetrafluoroethylene (ePTFE), and at least one air permeable layer adapted to be attached to the at least one layer of microporous ePTFE, wherein the at least one layer of microporous ePTFE and the at least one air permeable layer are adapted to substantially limit the passage of liquid while allowing for the passage of air through the at least one layer of microporous ePTFE and the at least one air permeable layer.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a perspective view of an example sealing gasket in accordance with an aspect of the present invention and positioned between a first component and a second component;

FIG. 2 is a perspective exploded view of the example sealing gasket positioned between the first component and the second component; and

FIG. 3 is a sectional view of a second example sealing gasket in accordance with another aspect of the present invention.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

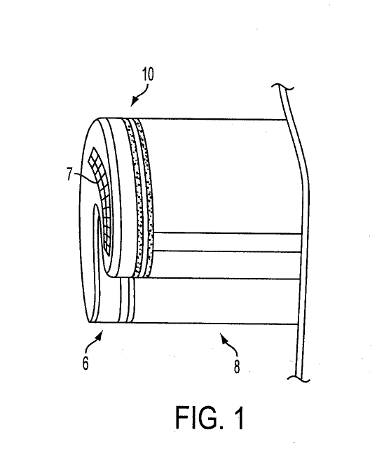

FIG. 1 illustrates a breathable gasket according to one aspect of the invention. An example embodiment of a breathable gasket can be used to seal two components together while minimizing the passage of liquid through the gasket 10. As shown in FIG. 1, the gasket 10 is positioned between a first mating component 6 and a second mating component 8 to provide a seal. The first mating component 6 may include an opening 7 allowing for air to pass through the first mating component 6, into the opening 7, through the gasket 10, and into the second mating component 8. The gasket 10 may be used in a number of different environments, such as in electrical applications, pressure and pneumatic applications, battery applications, etc. For instance, the gasket 10 may be used in a micropneumatic valve application which requires the release of air pressure to avoid pressure buildup.

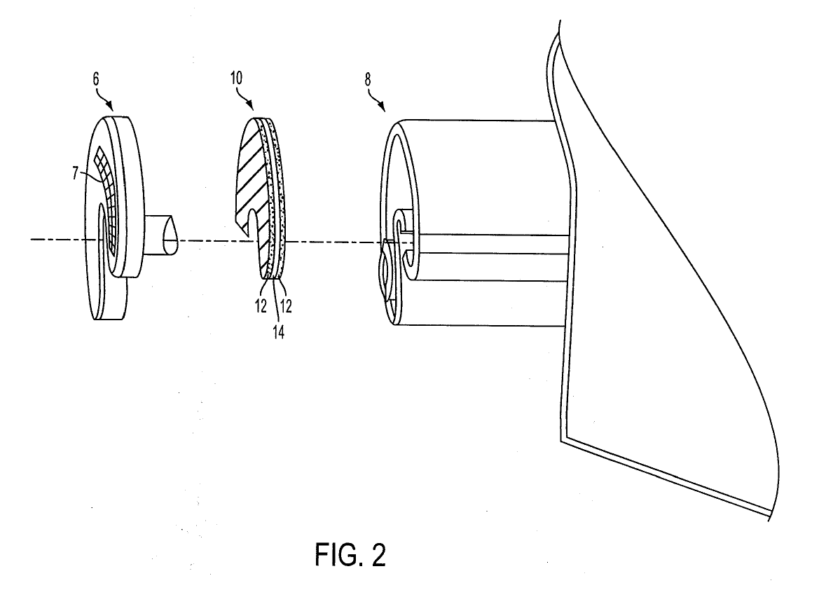

FIGS. 1 and 2 illustrate an example embodiment of the gasket 10. The gasket 10 may comprise a number of varying shapes, depending on the application. For instance, the gasket 10 may be sized and shaped to match the mating parts. In such an example, the gasket 10 may be circular, oval, square, etc. Similarly, the gasket 10 may be disc shaped with no hole in the middle. Similarly, the size of the gasket 10 varies depending on the application and in one example may have a diameter between 5 and 13 millimeters (mm). However, the gasket diameter may be smaller or larger.

The gasket 10 may be hydrophobic on both sides, such that the gasket 10 prevents or resists the passage of liquids, including water, through the gasket. The gasket 10 is gas permeable, such that the gasket permits the passage of gases, including air, carbon dioxide, water vapor, etc. through it. As will be described below, an oleophobic treatment may be applied to the gasket to improve oleophobicity, and, thus, resistance to oils, chemicals, or the like. The addition of the oleophobic treatment increases the resistance of the gasket 10 to being fouled by oil or oily substances from either side of the gasket 10.

Referring now to FIG. 2, the example gasket 10 include a polymeric microporous layer, hereinafter referred to as a layer of microporous ePTFE 12 that allows the flow of gases, such as air or water vapor, into and/or through the gasket. The layer of microporous ePTFE 12 may comprise an expanded polytetrafluoroethylene (PTFE) layer.

The layer of microporous ePTFE 12 includes a plurality of pores extending completely through the layer between opposite surfaces, thus allowing the layer of microporous ePTFE 12 to be air permeable. The average size of the pores in the layer of microporous ePTFE 12 may vary depending on the application, but is sufficient to be deemed microporous. For instance, the pore size may be in the range of 0.005 microns to 10.0 microns. For applications requiring a very low airflow through the gasket 10, such as in battery applications, the average pore size of the layer of microporous ePTFE 12 may be closer to the low end of the range, such as 0.005 to 0.02 microns. For applications requiring a greater airflow through the gasket 10, such as in micropneumatic valve applications, the average pore size of the layer of microporous ePTFE 12 may be closer to the high end of the range, such as up to 10.0 microns.

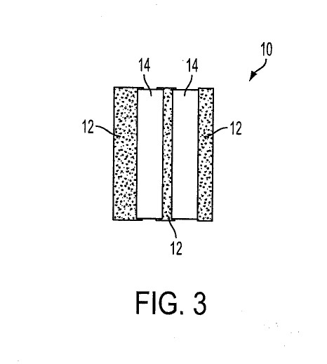

The gasket 10 may include one or more layers of microporous ePTFE 12. For example, in the shown embodiment of FIG. 2, the gasket 10 includes two layers of microporous ePTFE 12 surrounding a support fabric 14. However, greater or less than two layers of microporous ePTFE 12 may be used, depending on the application. For instance, in the shown embodiment of FIG. 3, the gasket 10 includes multiple microporous ePTFE layers. Applications requiring a very low airflow through the gasket 10 may include multiple microporous ePTFE layers. Applications requiring a greater airflow through the gasket 10 may include fewer microporous ePTFE layers, such as two layers or even a single layer of microporous ePTFE. Similarly, the arrangement of the layers of microporous ePTFE 12 also depends on the application. The layers of microporous ePTFE 12 may be positioned adjacent to each other side by side, or may be separated by the support fabric 14.

Many expanded PTFE membranes suitable for filtering or venting applications are relatively thin and delicate. The support fabric 14, such as a substrate backer, may be included in the gasket to provide support to the layer of microporous ePTFE 12. Furthermore, the support fabric 14 may provide the desired thickness and compressibility required for the gasket 10 based on the application. The support fabric 14 may further restrict or prevent the flow of the same and/or different particles and fluids as the layer of microporous ePTFE 12 and/or protect the layer of microporous ePTFE 12 or other layers from damage.

The support fabric 14 may be made from a number of materials, including a textile backer, a felt scrim of polymeric material, or a porous woven or nonwoven textile, felt, screen, net, or the like. Suitable polymeric materials for the support fabric 14 include, but are not limited to, polyester, polyethylene, a polyester-polyethylene blend, polypropylene, etc. For instance, in a low temperature application, polyester, polyethylene or a blend may be used. In a moderate temperature application requiring chemical resistance, polypropylene may be used. In a high or moderately high temperature application, Teflon felt or a high temperature felt or screen may be used. It is to be understood, however, that the support fabric 14 is not limited to the above mentioned materials, and may comprise a number of different materials depending on the application.

As shown in FIGS. 2 and 3, the support fabric 14 and layers of microporous ePTFE 12 are adapted to be attached to each other. Attachment limits the shifting and movement between layers of the support fabric and microporous ePTFE which may create unwanted pockets, blisters, gaps, or the like between the layers. The presence of pockets, blisters, gaps, or the like may decrease the consistency of permeability through the gasket 10. One method of attaching the support fabric 14 to the layers of microporous ePTFE 12 may include lamination. A number of lamination methods are available, including thermal lamination, adhesive lamination, edge lamination, etc.

Microporous ePTFE membrane, while having excellent hydrophobic properties, is known to be oleophilic. That is, the material forming the layer of microporous ePTFE 12 is susceptible to contamination by absorbing oil. Once this occurs, the contaminated regions of the ePTFE membrane are considered “fouled.” Once the ePTFE membrane is fouled, the pores can be easily wet by certain liquids, including water, and the ePTFE membrane is no longer considered hydrophobic.

The gasket 10 may be treated to reduce fouling and promote oleophobic properties of both the layers of microporous ePTFE and the support fabric 14. Treatment of the gasket 10 will provide further resistance to chemicals and liquids. A number of different oleophobic treatments and methods may be used. For instance, one or all of the layers may be treated. Similarly, either the ePTFE membrane, the support fabric, or both may be treated. The treatment may also occur before lamination or after lamination.

The oleophobic treatment includes depositing the treatment material on the surfaces of the layers of microporous ePTFE 12 and support fabric 14. The treatment results in a thin and even coating applied to substantially all of the surfaces of the gasket 10. After a predetermined amount of treatment material is deposited on a surface, the pore sizes are not dramatically reduced in flow area from that of an untreated laminated article. Improved oleophobic properties are therefore realized on any surface that has been treated.

The oleophobic treatment material may comprise a number of suitable materials, including a fluorinated polymer treatment or a perfluoroalkyl portion. One such fluorinated polymer treatment material may be a perfluorakyl acrylic copolymer referred to as Fabati 100. Fabati 100 was synthesized in MIBK (methyl isobutyl ketone) utilizing TAN [1,1,2,2,-tetrahydroperfluorooctyl acrylate]; butyl acrylate; a cross-linking agent TMI (isopropenyl-a,a-dimethylbenzyl isocyanate); Vazo 52 initiator [2,3-dimethyl-2,2′-azobispentanenitrile]. The Fabati 100 treatment material may be cross-linked by a post-treatment cure with heat. Another suitable perfluorakyl acrylic copolymer is Fabati 200. Fabati 200 is similar to Fabati 100 but does not have the cross-linking agent (TMI) and HBA [4-hydroxybutyl acrylate] is used instead of butyl acrylate. Thus, the Fabati 200 treatment material does not require post-treatment heating.

A variety of inorganic solvents can be used in the solution containing the oleophobic fluorinated polymer treatment material. The term “inorganic solvent” refers to non-aqueous solvents and combinations of non-aqueous solvents, and, in particular, to solvents comprising inorganic compounds. Suitable inorganic solvents may include carbon dioxide (CO₂), ammonia (NH₃), urea [(NH₂)₂CO], inorganic acids, such as hydrochloric acid, sulfuric acid, carbon tetrachloride and carbon tetrafluoride and oxides of carbon such as carbon dioxide (CO₂), carbon monoxide (CO), potassium carbonate, and sodium bicarbonate. A choice of solvent or solvents may be affected by a variety of factors including solubility of the treatment material in the solvent, molecular weight of the solvent and polarity of the solvent. In some examples, the treatment material may be completely dissolved in the inorganic solvent. In other examples, however, the treatment material is not fully dissolved in the inorganic solvent.

As described above, the support fabric 14 and layers of microporous ePTFE 12 may be treated together prior to, or subsequent to lamination of the support fabric 14 and layers of microporous ePTFE 12. During treatment, the fluorinated polymer solution wets and saturates the support fabric 14 and layers of microporous ePTFE 12. The use of an inorganic solvent may facilitate the distribution of the fluorinated polymer treatment material throughout the support fabric 14 and layers of microporous ePTFE 12. The inorganic solvent is then removed. The fluorinated polymer treatment material attaches to the expanded PTFE membrane and support fabric and enhances the oleophobicity and both surfaces of the gasket.

As described above, the air permeability of the gasket 10 may vary depending on the application. Some factors involved in the variability of permeability include, but are not limited to the average pore size of the layer of microporous ePTFE 12 and support fabric 14, the number of layers of support fabric 14 or microporous ePTFE, compression of the gasket 10, etc. In some applications, the air permeability through the gasket 10 may be 0.01 cubic feet per minute (CFM) per square foot at 0.5″ water column pressure drop as determined by ASTM D 737 test at 125 Pascal pressure drop. The air permeability may be even lower, however, such as 0.005 CFM in applications requiring very moderate diffusion with little airflow, such as a battery application. The air permeability may be much higher than 0.01 CFM at 0.5″ water column pressure drop as well, including up to 14 to 16 CFM.

The operation of the gasket 10 will now be described. As described, the gasket 10 may be used in a number of different environments, some of which require air flow between two components. In FIG. 1, the first mating component 6 includes the opening 7, allowing for ambient air to pass through the first mating component 6. Air may pass through the opening 7 and through the gasket 10. Factors such as the pore size, number of layers, etc. of the gasket 10 determine the air permeability of the gasket 10, and therefore, the amount of air that passes through. Any fluids, liquids solids or the like is prevented from passing through the gasket 10. After passing through the gasket 10, air enters the second mating component 8. Similarly, air may pass from the second mating component 8, through the gasket 10, and out of the opening 7. Therefore, the gasket 10 provides an air permeable seal between the two components.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. An air permeable gasket for providing a seal, comprising:
at least one layer of microporous expanded polytetrafluoroethylene (ePTFE); and
at least one air permeable layer laminated to the at least one layer of microporous ePTFE;
wherein the at least one layer of microporous ePTFE and the at least one air permeable layer are adapted to substantially limit the passage of liquid while allowing for the passage of air through the at least one layer of microporous ePTFE and the at least one air permeable layer.

2. The gasket of claim 1, wherein the at least one layer of microporous ePTFE comprises two layers of microporous ePTFE.

3. The gasket of claim 2, wherein the at least one air permeable layer is adapted to be positioned between the two layers of microporous ePTFE.

4. The gasket of claim 1, wherein the at least one air permeable layer comprises a textile backer.

5. The gasket of claim 1, wherein the at least one layer of microporous ePTFE has a 0.005-10 micron pore diameter.

6. The gasket of claim 1, wherein the at least one air permeable layer comprises a nonwoven felt material.

7. The gasket of claim 1, wherein the at least one air permeable layer comprises a nonwoven material.

8. The gasket of claim 1, wherein the at least one air permeable layer comprises a woven textile material.

9. The gasket of claim 1, wherein the air permeability through the at least one layer of microporous ePTFE and the at least one air permeable layer is at least 0.01 at 0.5″ water column pressure drop cubic feet per minute (CFM) per square foot as determined by ASTM D 737 testing.

10. A gasket for providing a seal, comprising:
at least one microporous layer;
at least one air permeable layer laminated to the at least one microporous layer, wherein the air permeability through the at least one air permeable layer laminated to the at least one microporous layer is at least 0.01 cubic feet per minute (CFM) per square foot at 0.5″ water column pressure drop as determined by ASTM D 737 testing.

11. The gasket of claim 10, wherein the at least one microporous layer comprises microporous expanded polytetrafluoroethylene (ePTFE).

12. The gasket of claim 11, wherein the at least one layer of microporous ePTFE comprises two layers of microporous ePTFE.

13. The gasket of claim 12, wherein the at least one air permeable layer is adapted to be positioned between the two layers of microporous ePTFE.

14. The gasket of claim 10, wherein the at least one air permeable layer comprises a textile backer.

15. The gasket of claim 11, wherein the at least one layer of microporous ePTFE has a 0.005-10 micron pore diameter.

16. The gasket of claim 10, wherein the at least one air permeable layer comprises a nonwoven felt material.

17. The gasket of claim 10, wherein the at least one air permeable layer comprises a nonwoven material.

18. The gasket of claim 10, wherein the at least one air permeable layer comprises a woven textile material.

19. An article comprising:
at least one layer of microporous expanded polytetrafluoroethylene (ePTFE); and
at least one air permeable layer adapted to be attached to the at least one layer of microporous ePTFE;
wherein the at least one layer of microporous ePTFE and the at least one air permeable layer are adapted to substantially limit the passage of liquid while allowing for the passage of air through the at least one layer of microporous ePTFE and the at least one air permeable layer.

20. The article of claim 19, wherein the air permeability through the at least one layer of microporous ePTFE and the at least one air permeable layer is at least 0.01 cubic feet per minute (CFM) per square foot at 0.5″ water column pressure drop as determined by ASTM D 737 testing.
